(19) United States
(12) Patent Application Publication
(10) Pub. No.: US 2003/0029249 A1
(43) Pub. Date: Feb. 13, 2003

(54) Electromagnetic flowmeter

(76) Inventor: Ray Keech, Stroud (GB)

Correspondence Address: Martin G. Linihan, Hodgson Russ LLP, Suite 2000, One M&T Plaza, Buffalo, NY, 14203-2391, US

(21) Appl. No.: 10/187,538

(22) Filed: Jul. 1, 2002

(30) Foreign Application Priority Data
Jul. 2, 2001 (GB) GB0116168.6

(51) Int. Cl. G01F 1/58

(52) U.S. Cl. 73/861.12

(57) ABSTRACT

In an AC electromagnetic flowmeter, a method is proposed for obtaining reliable measurement of flow across a variety of flow rates which has good stability and is immune from noise. The method comprises

exciting the field generating coils of the flowmeter with an excitation signal comprising a first, relatively low frequency, component and a second, relatively high frequency, component;

analyzing the induced electrode signal into a first flow measurement component generated substantially by the first excitation component and a second flow measurement component generated substantially by the second excitation component; and

combining the first flow measurement component and second flow measurement component to obtain a measurement of flow based on both the first and second flow measurement components.

The present invention relates to electromagnetic flowmeters.

Electromagnetic flowmeters are well-known instruments for obtaining a measure of flow rate of a flowing fluid. Very briefly, electromagnetic flowmeters operate, as is well known, by passing a current through a coil to generate a magnetic field and detecting an electro-motive force, measured in volts, induced in a fluid passing through the field. The output voltage, E, is proportional to the product of the field, B, and flow velocity, v, and thus:

E=k1.B.v (equation 1).

It is generally assumed that the magnetic field strength in the coil is linearly proportional to the current, I, flowing in the coil so that:

B=k2.I (equation 2).

Thus, the output signal is proportional to the product of current and velocity, and can be expressed by substitution for B from equation (2) into equation (1) as:

E=k1.k2.I.v. (equation 3).

Flowmeters have been used for many years and work well. However, there are a number of problems associated with obtaining optimum results and many of these have been addressed in the past.

AC and DC flowmeters are known in the art, AC flowmeters using an AC current to drive the field generating coils and DC flowmeters using a direct current or a pulsed direct current to drive the field generating coils. A disadvantage of DC flowmeters is that they can be less accurate or more prone to flow-induced noise than a comparable AC flowmeter. On the other hand, a problem encountered with AC flowmeters is that eddy currents are induced in the body of the flowmeter or adjacent structure. These eddy currents may inhibit use of the flow meter, particularly at high frequencies.

The present invention is particularly concerned with AC flowmeters.

We have found that, in an AC electromagnetic flowmeter, it is difficult to obtain reliable measurement across a variety of flow rates which has good stability and is immune from noise.

Choice of operating frequency is an important consideration. With low frequencies, it becomes harder to eliminate flow-induced noise in the measurement and with higher frequencies, it becomes difficult to maintain accurate phase stability and to compensate for instability of the signal from the electrodes or to measure DC offsets accurately. In practice, the operating frequency chosen is set at a compromise between these constraints for a particular application.

Pursuant to the invention, it has been appreciated that these competing constraints can in fact both be satisfied.

In a first aspect, the invention provides a method of obtaining a measurement of flow in an electromagnetic flowmeter comprising

exciting the field generating coils of the flowmeter with an excitation signal comprising a first, relatively low frequency, component and a second, relatively high frequency, component;

analysing the induced electrode signal into a first flow measurement component generated substantially by the first excitation component and a second flow measurement component generated substantially by the second excitation component;

combining the first flow measurement component and second flow measurement component to obtain a measurement of flow based on both the first and second flow measurement components.

The first and second flow measurement components are advantageously obtained simultaneously or quasi-simultaneously and preferably substantially continuously.

The method may include deriving a first electrode signal (which may have relatively high stability) from the first flow measurement component.

The method may further include deriving a second electrode signal (which may have relatively high noise immunity) from the second flow measurement component.

The measure of flow thus obtained may have higher noise immunity than a measure of flow produced by the first flow measurement component and higher stability than the measure of flow produced by the second flow measurement component. Combining may be effected in various ways to obtain the benefits of the invention; a particularly simple but effective method will be described below. However, it will be appreciated that more sophisticated algorithms may be used to extract an optimum measurement from the two simultaneous signals which are provided according to the invention.

Extracting the first and second measurement signals includes multiplying the electrode signal by each fo respective first and second demodulation signals, each having the frequency of the respective one of the first and second excitation components and preferably being derived therefrom. Other methods may be used, including band-pass filtering, Fourier analysis and the like.

Combining may entail filtering the first flow measurement component to attenuate high-frequency components; that should reduce the effect of flow-induced noise. Combining may entail filtering the second flow measurement component to attenuate low-frequency components; that should reduce the effect of DC offsets or low frequency instability. Combining may entail identifying or obtaining a measure of sudden transitions based on the second flow measurement component and/or identifying or obtaining a measure of low frequency trends based on the first flow measurement component. It will be appreciated that the first and second flow measurement components, although derived from the electrode signal, will normally be available from a Digital Signal Processor which has extracted and pre-processed the raw electrode signal.

In this way, a better measure of flow can be obtained than that conventionally obtainable but without taking any greater time for measurement. It will be appreciated that the terms “relatively low” and “relatively high” are merely intended to be relative to the other component; in practical applications the “relatively high frequency” component may only have a frequency of the order of a hundred hertz or a few hundred hertz. Similarly, the references to stability and noise immunity are also relative. There is no requirement for specific tests to be employed nor for precise quantisation of stability and noise; those skilled in the art will normally have preferred methods of obtaining estimates of flow induced noise and signal stability.

It will generally be observed and such may be used to and do not necessarily connote; by observing In a preferred embodiment, the low frequency component is low-pass filtered to remove high frequency noise. Conversely, the high frequency component is preferably high-pass filtered to remove low frequency components.

More generally, the first flow measurement component is preferably processed to reduce high frequency components and to retain or to enhance low frequency components. The second flow measurement component is preferably processed to reduce low frequency components and to retain or to enhance high frequency components. Combining is preferably selected so that low frequency information is obtained predominantly from the first measurement component and high frequency information is obtained predominantly from the second measurement component.

Most preferably, the low frequency component is filtered through a low-pass filter which has a first break (cut) frequency and the high frequency component is high-pass filtered through a high-pass filter which has a second break (cut) frequency, wherein the first and second break frequencies match. Preferably the filtered components are combined by summing.

Preferably also, the second component is low-pass filtered prior to high-pass filtering. Preferably, the low-pass filter applied to the second component has a frequency corresponding to the frequency of the second excitation component. In this way, the low-pass filter effectively demodulates the high frequency component.

In a most preferred implementation, filtering is effected using a digital signal processor. This has the benefit that the filtering can be mathematically accurate and the high and low frequency components can be accurately combined simply by summing.

In a preferred application, the high frequency component has a frequency of the order of 200 Hz, preferably in the range 40 Hz-1 KHz, preferably above 60 Hz.

Preferably, the low frequency component has a frequency in the range 0.1 to 50 Hz, typically of the order of 15 Hz, preferably in the range 1-40 Hz.

The preferred break frequencies of both the high and low pass filters are preferably in the range 0.01 Hz to 5 Hz; this range has been found particularly useful in reducing noise typically encountered in a flow meter.

In an apparatus aspect, the invention provides an electromagnetic flowmeter comprising

means for exciting the field generating coils of the flowmeter with an excitation signal comprising a first, relatively low frequency, excitation component and a second, relatively high frequency, excitation component;

means for analysing the induced electrode signal into a first flow measurement component generated substantially by the first excitation component and a second flow measurement component generated substantially by the second excitation component;

means for combining the first and second flow measurement components to obtain a measurement of flow.

The means for analysing may include means for multiplying the electrode signal by each of the first and second excitation components of the excitation signal (or derivatives thereof) to extract the corresponding flow measurement components.

The invention may be most advantageously implemented in software in a Digital Signal Processor (DSP). A particular advantage of using a DSP is that “ideal” or mathematically accurate filtering can be performed, leading to better results than using an analogue filter; this is particularly important where summing is used to combine the components.

An embodiment of the invention will now be described, by way of example, with reference to the accompanying drawings in which:

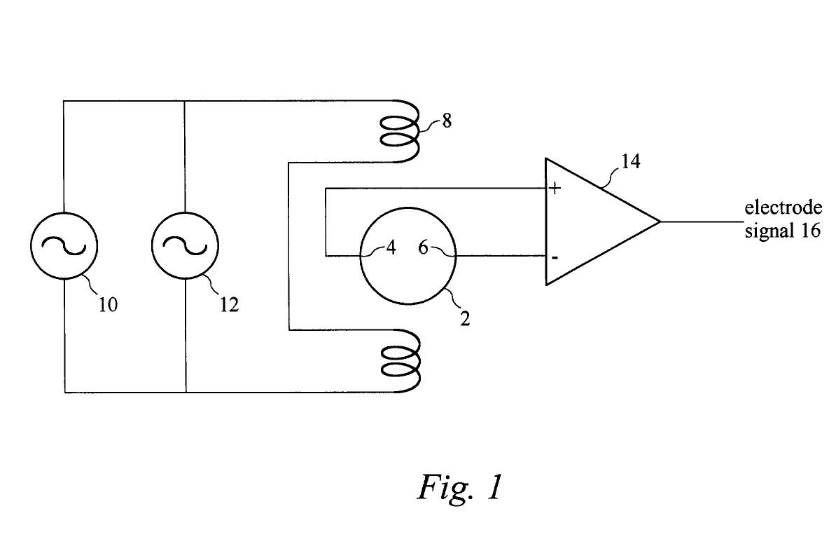

FIG. 1 is a schematic diagram of a flowmeter in accordance with an embodiment of the present invention; and

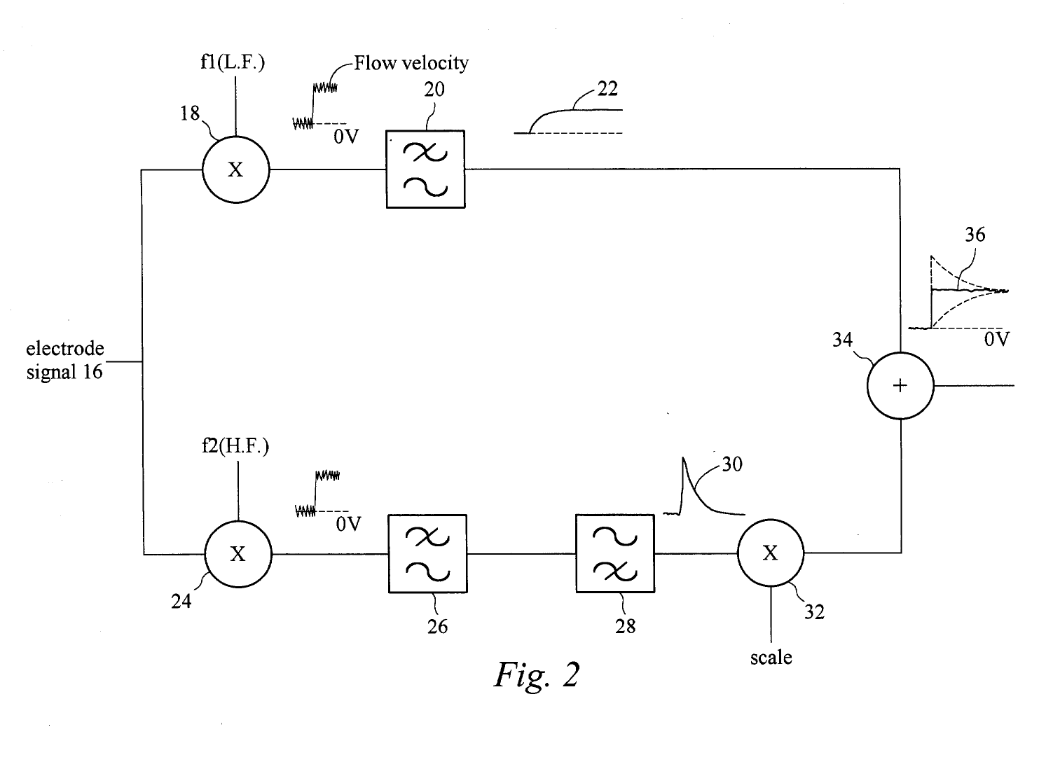

FIG. 2 is a schematic diagram of filtering of electrode signals in accordance with a particularly preferred implementation.

The flowmeter schematically shown in FIG. 1 comprises a tubular conduit 2 at whose inner surface sensing electrodes 4 and 6 are arranged. The voltage between sensing electrodes 4 and 6 is processed by amplifier 14 so as to provide electrode signal 16 representative of flow rate.

A magnetic field B is generated across the conduit by means of field coils 8 supplied with AC current from current sources 10 and 12. Current source 10 supplies AC current at relatively low frequency f1 (e.g. 10 Hz), and current source 12 at relatively high frequency f2 (e.g. 200 Hz). To obtain most useful benefits, preferably the higher frequency signal is at least double the frequency of the lower frequency signal, preferably at least five times greater.

As shown in FIG. 2, electrode signal 16 is supplied to multipliers 18 and 24. Electrode signal 16 is multiplied with frequency f1 at multiplier 18 and with frequency f2 at multiplier 24 so as to achieve synchronous detection. The signal resulting from multiplier 18 is then low-pass filtered at low-pass filter 20, whilst the signal resulting from multiplier 24 is high-pass filtered at high-pass filter 28 (optionally also low-pass filtered at low-pass filter 26, see below). The high and/or low pass filtered signals are then scaled at multiplier 32 and combined, e.g. by summing at adder 34, to provide the combined output signal 36.

In the preferred implementation the break frequency of high-pass filter 28 is the same as that of the low-pass filter 20. An accurate combined output can then be obtained simply by summing the high and low frequency components of the electrode signal.

Particularly if the frequency of the high frequency is much higher (as in the example given), there will normally be slightly reduced output at the higher frequency, due to various factors, including eddy current losses. Thus, summing the signals may not give a precisely accurate output. However, it has been found that this can readily be accommodated, simply by correcting the signals to compensate for the different frequency response of the meter. This can conveniently be achieved simply by linearly scaling; for example the output at the higher frequency may be multiplied by a correction factor, which will normally be in the range of about 1 to 3. A transfer function of the flow meter with frequency may be determined and/or stored, either for a class of meter or for an individual meter, in a calibration step, and used to correct the output for the frequency of excitation being employed.

Although sinusoidal excitation may conveniently be employed, the invention is not restricted to sinusoidal excitation and may also be employed with other (preferably continuous, e.g. synthetic) waveforms, such as sawtooths or triangular waveforms. It is to be noted, however, that square waveforms or pulse waveforms are preferably not employed as this may induce problems commonly associated with pulsed DC meters, which the invention seeks to avoid, and the frequency response to a square wave, which has substantial components at considerably higher frequencies than the basic frequency may be less predictable.

As mentioned above, the high frequency component can optionally be low-pass filtered at low-pass filter 26 (in addition to the high-pass filtering at high-pass filter 28). This serves to demodulate the signal.

While the present invention has been described in its preferred embodiments, it is to be understood that the words which have been used are words of description rather than limitation and that changes may be made to the invention without departing from its scope as defined by the appended claims.

Each feature disclosed in this specification (which term includes the claims) and/or shown in the drawings may be incorporated in the invention independently of other disclosed and/or illustrated features.

1. A method of obtaining a measurement of flow in an electromagnetic flowmeter comprising
exciting field generating coils of the flowmeter with an excitation signal comprising a first, relatively low frequency, component and a second, relatively high frequency, component;
analysing an induced electrode signal into a first flow measurement component generated substantially by the first excitation component and a second flow measurement component generated substantially by the second excitation component;
combining the first flow measurement component and second flow measurement component to obtain a measurement of flow based on both the first and second flow measurement components.

2. A method according to claim 1, wherein the first flow measurement component is low-pass filtered to remove high frequency noise.

3. A method according to claim 1, wherein the second flow measurement component is high-pass filtered to remove low frequency noise.

4. A method according to claim 1 wherein the first flow measurement component is filtered through a low-pass filter which has a first break frequency so as to produce a first filtered component and the second flow measurement component is high-pass filtered through a high-pass filter which has a second break frequency so as to produce a second filtered component, wherein the first and second break frequencies are equal.

5. A method according to claim 4 wherein the first and second filtered components are combined by summing.

6. A method according to claim 1 wherein at least one of the first and second flow measurement components is corrected or scaled to compensate for differences in response characteristic of the flow meter at the first and second frequencies.

7. A method according to claim 5, wherein the magnitude of the second flow measurement component is increased relative to the first flow measurement component to compensate for reduced flow meter response at higher frequency.

8. A method according to claim 7, wherein compensation is carried out prior to said summing.

9. A method according to claim 1 wherein the second measurement component is low-pass filtered prior to high-pass filtering.

10. A method according to claim 1 wherein filtering is effected using a digital signal processor.

11. A method according to claim 1 wherein the high frequency component has a frequency in the range 40 Hz-1 KHz.

12. A method according to claim 1 wherein the low frequency component has a frequency in the range 0.1-50 Hz.

13. A method according to claim 1 wherein the high frequency component has a frequency at least double the low frequency component.

14. A method according to claim 1, wherein the first and second measurement signals are extracted by multiplying the electrode signal by each of respective first and second demodulation signals, each having the frequency of the respective one of the first and second excitation components and preferably being derived therefrom.

15. A method according to claim 1, wherein the first flow measurement component is processed to reduce high frequency components and to retain or to enhance low frequency components.

16. A method according to claim 1, wherein the second flow measurement component is processed to reduce low frequency components and to retain or to enhance high frequency components.

17. A method according to claim 1, wherein the combining is selected so that low frequency information is obtained predominantly from the first flow measurement component and high frequency information is obtained predominantly from the second flow measurement component.

18. An electromagnetic flowmeter comprising
means for exciting field generating coils of the flowmeter with an excitation signal comprising a first, relatively low frequency, component and a second, relatively high frequency, component;
means for analysing an induced electrode signal into a first flow measurement component generated substantially by the first excitation component and a second flow measurement component generated substantially by the second excitation component;
means for combining the first and second flow measurement components to obtain a measurement of flow.

19. An electromagnetic flowmeter comprising:
a signal synthesiser for exciting field generating coils of the flowmeter with an excitation signal comprising a first, relatively low frequency, component and a second, relatively high frequency, component;
a signal processor for analysing an induced electrode signal into a first flow measurement component generated substantially by the first excitation component and a second flow measurement component generated substantially by the second excitation component;
an output processor for combining the first and second flow measurement components to obtain a measurement of flow.

20. A computer program or computer program product comprising instructions for performing a method according to claim 1.
